(19) United States
(12) Patent Application Publication
(10) Pub. No.: US 2003/0126190 A1
(43) Pub. Date: Jul. 3, 2003

(54) Service providing software system storage medium, service providing program storage medium, service providing system, and service providing device

(75) Inventors: Yuji Wada, Kawasaki (JP); Tadashige Iwao, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/264,911

(22) Filed: Oct. 7, 2002

(30) Foreign Application Priority Data
Dec. 28, 2001 (JP) 2001-399263

(51) Int. Cl. G06F 15/16

(52) U.S. Cl. 709/201

(57) ABSTRACT

A system includes an attribute information DB accumulating attribute information which is a material for evaluating the qualification for receiving a provided service, a policy DB accumulating policies having a condition of receiving a service and a service description section describing a service provided when the condition is satisfied, a policy evaluation section obtaining the information indicating whether or not the user has the attribute information satisfying the condition described in the condition description section in the policy, and a function execution section providing a service described in the service description section of the policy on condition that the information that the user has the attribute information satisfying the condition is acquired.

### BACKGROUND OF THE INVENTION

1. Field of the Invention

The present invention relates to a service providing software system storage medium storing a service providing software system including programs and files for providing services, a service providing program storage medium storing a service providing program for providing services, a service providing system for providing services, and a service providing device for providing services.

2. Description of the Related Art

Recently, a service of a television broadcast of satellite television, subscription television, etc. which can be received only by a subscriber to the broadcast system, and a service receivable through the Internet only by subscribers of a service system are offered.

Described below for example is a subscription television broadcast which can be used only by a subscriber. The subscription television broadcast in Japan can be realized on nearly 100 channels. Subscribers are not to subscribe to all television broadcasts on the nearly 100 channels, but select and subscribe only to the channels of desired programs.

The subscriber can receive and enjoy a television broadcast on the channel he or she subscribes to in a specific place such as home, etc. However, when the subscriber stays in a hotel on a business trip, etc., it is possible that the subscriber cannot enjoy a desired program unless the hotel subscribes to all channels.

In this case, subscribers request to use services of systems to which they subscribe regardless of the location of the subscribers, that is, regardless of home or other places.

For another example, assume that a user generally uses a service of reading news by receiving the news distributed on a notebook type personal computer (hereinafter referred to as a notebook PC) and a PDA. Such a manner is the typical usage for the user to utilize the service. However, in the environment with a large monitor screen, although the equipment connected to the large monitor screen is not the user's equipment, and is used by unspecified users, the user requests to display the news on the large monitor screen if the user is in the position of using the large monitor screen because the user subscribes to the service of distributing the news.

As described above, services have been basically and conventionally received in the service system associated with predetermined equipment and facilities. In this case, it is necessary for a user to move to the place where the equipment and facilities are mounted so that the service can be offered. However, users desire that the services which they have the rights to receive move along with them wherever they go, and that they receive such services using the equipment and facilities at the destination.

### SUMMARY OF THE INVENTION

The present invention has been developed to solve the above mentioned problems, and aims at providing a service providing software system storage medium storing a service providing software system appropriate for providing a service moving along with a user, a service providing program storage medium storing a service providing program, a service providing system, and a service providing device.

The service providing software system storage medium according to the present invention for attaining the above mentioned object includes:

an attribute information file describing attribute information which is a material for evaluation of the qualification for receiving a service;

a policy description file having a condition description section describing a condition of receiving a service, and a service description section directly or indirectly describing a service to be provided when the condition described by the condition description section is satisfied; and

a service providing program which is executed in a computer and directs the computer to operate as a service providing device including a policy evaluation section for obtaining information indicating whether or not an attribute information file includes attribute information satisfying the condition described in the condition description section in the policy description file, and a function execution section for interpreting the description of the service described in the service description section of the policy description file, depending on the acquisition by the policy evaluation section of the information indicating the existence of the attribute information matching the condition.

In the description above, ‘directly or indirectly describing a service’ indicates that a service can be directly described, and an address, etc. indicating the location of the program, etc. describing the service can be described.

It is desired that the above mentioned attribute information file cannot be transferred from the storage medium storing the attribute information file to another storage medium or can be transferred after a predetermined authentication procedure, and it is desired that the policy description file can be distributed after being copied through peer-to-peer communications.

In the service providing software system stored in the service providing software system storage medium according to the present invention, an attribute information file can be written to, for example, an IC card from which the file cannot be transferred so that it can be carried, or the attribute information stored in the computer in the user's home can be stored and carried in a storage medium through an authentication procedure such as, for example, inputting a password, etc. so that a service can be offered using equipment at the destination. At this time, the policy description file is distributed after being copied through the peer-to-peer communications. Therefore, it is not necessary to carry the policy description file when it is widely spread and is provided for equipment at the destination. However, if it is not certain whether or not the equipment at the destination is provided with the policy description file, then it is carried after being stored in, for example, the above mentioned IC card, a storage medium, etc.

Otherwise, in an environment of constantly using the attribute information file and the policy description file through a communications line such as Internet, etc., the attribute information file or the policy description file is not carried, but it is possible to carry the address indicating the position in which each of them is placed.

Thus, only if the equipment at the destination is in an environment in which the service providing program has been installed and is executable, then the policy description file is passed to the equipment at the destination, the attribute information is not passed to the equipment at the destination but managed by the user, the equipment at the destination refers to the attribute information of the user, the user recognizes that the condition of receiving the service is satisfied, and the service is offered to the user.

If the service providing program is widely spread, a user can receive a service anywhere by, for example, carrying the own attribute information file and the policy description file as necessary.

The service providing program storage medium for attaining the above mentioned object of the present invention is a service providing program storage medium storing a service providing program which is executed in a computer and directs the computer to operate as a service providing device for providing a service, and includes: a policy evaluation section for obtaining information indicating whether or not an attribute information file describing attribute information which is a material for evaluation of the qualification for receiving a service includes attribute information satisfying the condition described in the condition description section in the policy description file having a condition description section describing a condition of receiving a service, and a service description section directly or indirectly describing a service to be provided when the condition described by the condition description section is satisfied; and a function execution section for interpreting the description of the service described in the service description section of the policy description file, depending on the acquisition by the policy evaluation section of the information indicating the existence of the attribute information matching the condition.

In the service providing program storage medium according to the present invention, it is desired that the above mentioned attribute information file cannot be transferred from the storage medium storing the attribute information file to another storage medium or can be transferred after a predetermined authentication procedure, and it is desired that the policy description file can be distributed after being copied through peer-to-peer communications.

Furthermore, the service providing system according to the present invention for attaining the above mentioned object includes:

an attribute information storage section storing an attribute information file describing attribute information which is a material for evaluation of the qualification for receiving a service;

a policy storage section storing a policy description file having a condition description section describing a condition of receiving a service, and a service description section directly or indirectly describing a service to be provided when the condition described by the condition description section is satisfied;

a policy evaluation section obtaining information indicating whether or not an attribute information file includes attribute information satisfying the condition described in the condition description section in the policy description file; and

a function execution section interpreting the description of the service described in the service description section of the policy description file, depending on the acquisition by the policy evaluation section of the information indicating the existence of the attribute information matching the condition.

The service providing system is configured by a combination of the above mentioned service providing software system and an apparatus or apparatuses (hardware system) in which files and programs forming the service providing software system are collectively or individually installed.

In the service providing system according to the present invention, it is also desired that the attribute information storage section is provided in another device than a device including the policy evaluation section, and the policy evaluation section inquires of the device including the attribute information storage section whether or not attribute information satisfying the condition described in the condition description section in the policy description file exists in the attribute information file, and obtains the information as to whether or not the attribute information satisfying the condition of receiving a corresponding service exists according to an answer from the device including the attribute information storage section.

In the above service providing system according to the present invention, it is preferred that the attribute information storage section can store the attribute information file such that the file cannot be transferred to a storage medium other than the attribute information storage section, or such that the file can be transferred only after a predetermined authentication procedure, and it is preferred that the policy description storage section can store the policy description file such that the file can be freely distributed through the peer-to-peer communications.

The service providing device according to the present invention for attaining the above mentioned object includes:

a policy evaluation section obtaining information indicating whether or not an attribute information file describing attribute information which is a material for evaluation of the qualification for receiving a service includes attribute information satisfying the condition described in the condition description section in the policy description file having a condition description section describing a condition of receiving a service, and a service description section directly or indirectly describing a service to be provided when the condition described by the condition description section is satisfied; and

a function execution section for interpreting the description of the service described in the service description section of the policy description file, depending on the acquisition by the policy evaluation section of the information indicating the existence of the attribute information matching the condition.

In the service providing device, it is also desired that the attribute information file is stored in an attribute information storage medium other than the service providing device, and the policy evaluation section directly accesses the attribute information storage medium or inquires of the device for accessing the attribute information storage medium to obtain the information as to whether or not the attribute information satisfying the condition described in the condition description section in the policy description file is included in the attribute information file stored in the attribute information storage medium.

It is desired that the attribute information file used in the service providing device according to the present invention cannot be transferred from the storage medium storing the attribute information file to another storage medium or can be transferred after a predetermined authentication procedure, and it is desired that the policy description file used in the service providing device of the present invention can be distributed after being copied through peer-to-peer communications.

### BRIEF DESCRIPTION OF THE DRAWINGS

FIG. 1 shows the outline of an embodiment of the service providing system according to the present invention;

FIG. 2 shows the internal configuration of each equipment shown in FIG. 1;

FIG. 3 shows an embodiment of the service providing software system stored in a service providing software system storage medium according to the present invention;

FIG. 4 is a flowchart of the operation of the policy management section configuring the service providing system shown in FIG. 1;

FIG. 5 is a flowchart of the operation of the attribute information management section configuring the service providing system shown in FIG. 1;

FIG. 6 is a flowchart of the operation of the attribute information message processing sections configuring the service providing system shown in FIG. 1;

FIG. 7 is a flowchart of the operation of the policy evaluation section of the service providing system shown in FIG. 1;

FIG. 8 is a flowchart of the operation of the function execution section of the service providing system shown in FIG. 1;

FIG. 9 shows an example of a policy;

FIG. 10 shows a use style of the present invention using a policy shown in FIG. 9;

FIG. 11 shows a use style of the present invention using a policy shown in FIG. 9;

FIG. 12 shows a use style of the present invention using a policy shown in FIG. 9; and

FIG. 13 shows another use style of the present invention.

### DETAILED DESCRIPTION OF THE PREFERRED EMBODIMENTS

The embodiments of the present invention are described below.

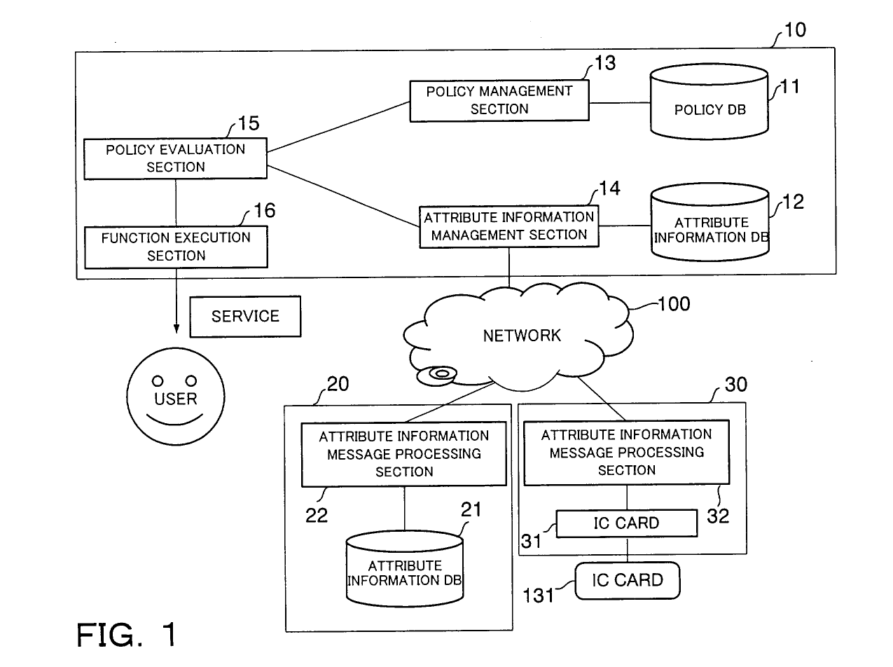

FIG. 1 shows the outline of an embodiment of the service providing system according to the present invention.

The service providing system according to the present embodiment is configured by three pieces of equipment 10, 20, and 30 through a network 100 (Internet in this embodiment). The equipment 10 provides a service for a user. In the present embodiment, only the equipment 10 can satisfy the necessary configuration required to provide a service for a user, but the equipment 20 and 30 are also provided in this embodiment to indicate that there can be the attribute information in the ends connected through a network.

Although it does not matter whether or not each equipment 10, 20, and 30 appears as a computer, but each of them functions as a computer executing a program in it.

The equipment 10 comprises a policy DB (database) 11 storing a policy description file, and the policy DB 11 is managed by a policy management section 13.

The policy description file comprises a condition description section describing a condition of receiving a service and a service description section directly or indirectly describing a service to be provided for a user satisfying the condition described in the condition description section. ‘Directly describing a service’ refers to directly describing a program, etc. for executing a service. ‘Indirectly describing a service’ refers to that at least a part of a program is not directly described for execution of a service in the service description section, and an address, URL, etc. indicating the location of the program required to execute the service are described. In this example, the contents described in the policy description file are referred to as a policy.

The equipment 10 is provided with an attribute information DB 12 storing an attribute information file, and the attribute information DB 12 is managed by an attribute information management section 14. The attribute information management section 14 not only manages the attribute information DB 12 in the equipment 10, but also manages the attribute information in an attribute information DB 21 provided in the equipment 20 or in an IC card 131 through a network 100.

Attribute information is the material for evaluation of the qualification of receiving a service, and is managed for each user.

Additionally, the equipment 10 comprises a policy evaluation section 15 and a function execution section 16.

The policy evaluation section 15 receives a policy description file describing a service used by a user from the policy management section, requests the attribute information management section 14 to check whether or not the user has attribute information satisfying the condition of receiving the service in the policy description file, receives a check result from the attribute information management section 14, and requests the function execution section 16 to execute the service if the user has the attribute information satisfying the condition of receiving the service described in the policy description file.

In response to the request to execute the service from the policy evaluation section 15, the function execution section 16 acts based on the contents described in the service description section of the policy by interpreting the description in the service description section of the policy description file, executing the service described in the file, or requesting a supplier of a service to offer the service, etc.

The equipment 20 is provided with the attribute information DB 21. The attribute information DB 21 is managed by an attribute information message processing section 22 according to the message transmitted from the attribute information management section 14 of the equipment 10 through the network 100.

The equipment 30 further comprises an IC card read/write section 31 for accessing the IC card 131.

The IC card 131 stores attribute information, and the attribute information in the IC card 131 is managed by an attribute information message processing section 32 according to a message transmitted from the attribute information management section 14 of the equipment 10 through a network.

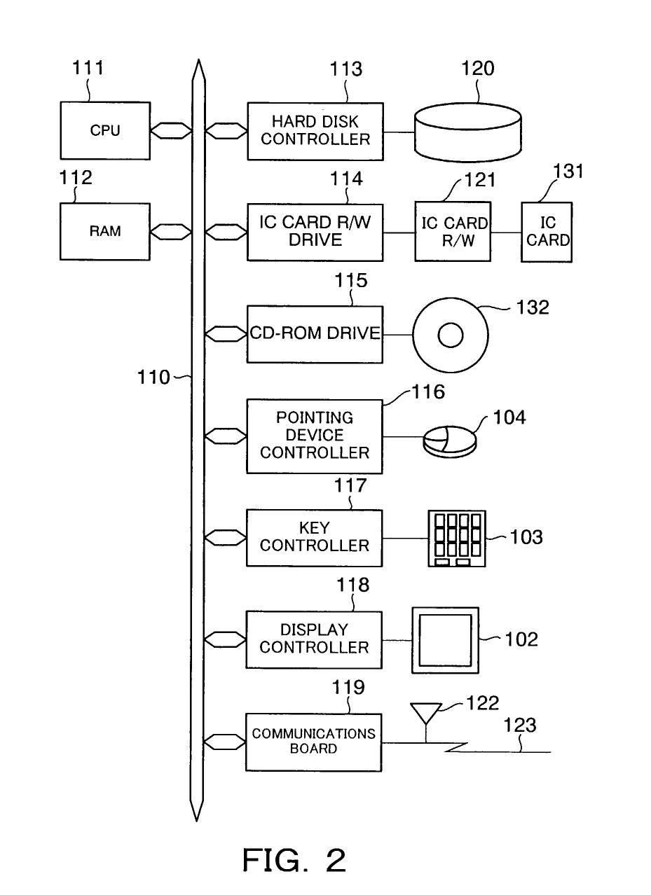

FIG. 2 shows the internal configuration of each equipment shown in FIG. 1. It shows a general-purpose configuration, and the configuration shown in FIG. 2 with respect to each of the equipment 10, 20, and 30 is amended as necessary. For example, in the equipment 30, it is necessary to access an IC card, and therefore, an IC card reader/writer drive 114 and an IC card reader/writer 121 are required for the equipment 30. On the other hand, since it is not necessary to access the IC card in the equipment 10 and 20, the equipment 10 and 20 do not require the IC card reader/writer drive 114 and the IC card reader/writer 121. However, the equipment 10 shown in FIG. 1 can also be configured to comprise the IC card reader/writer drive 114 and the IC card reader/writer 121 so that the equipment 10 can read the attribute information stored in the IC card 131.

Shown in FIG. 2 are a hard disk 120 storing various programs and files; a hard disk controller 113 accessing the hard disk 120; the IC card reader/writer 121 accessing the IC card 131; the IC card reader/writer drive 114 for driving the IC card reader/writer 121; CD-ROM drive for driving CD-ROM 132; a pointing device controller 116 for controlling a pointing device 104; a key controller 117 for monitoring an operation of a key 103; a display controller 118 for controlling a display 102; a communications board 119, to which an antenna 122 is connected, or which is connected to a communications line 123, for communication through the network 100 shown in FIG. 1; a CPU 111 for executing a program; and RAM 112 for use as a work area when a program in the hard disk 120 is developed for execution by the CPU, and the CPU executes the program in the hard disk 120. Among them, the CPU 111, the RAM 112, the hard disk controller 113, the IC card reader/writer drive 114, a CD-ROM drive 115, the pointing device controller 116, the key controller 117, the display controller 118, and the communications board 119 are interconnected through a bus 110.

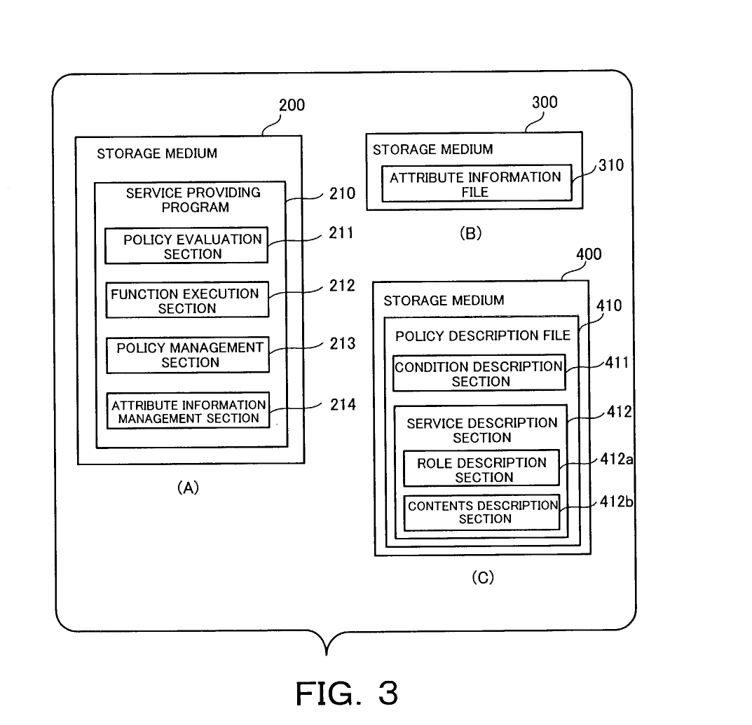

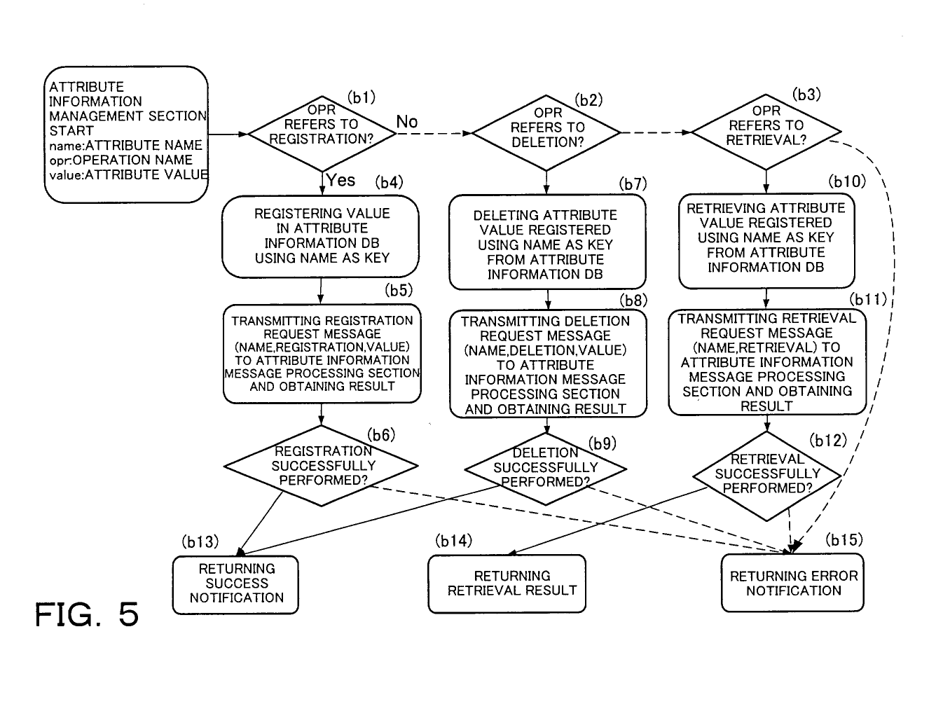

FIG. 3 shows an embodiment of the service providing software system stored in a service providing software system storage medium according to the present invention. The service providing software system functions as the equipment 10 shown in FIG. 1 by installing them in the computer shown in FIG. 2. The software installed in the equipment 20 and 30 shown in FIG. 1 is omitted in the attached drawings and explanation, but the software required to satisfy the effects explained by referring to FIG. 1, and the effects explained by referring to FIG. 5 etc. is installed.

The programs and files configuring the service providing software system shown in FIG. 3 are stored separately in three storage media 200, 300, and 400. This indicates that the programs and files stored in these three media are separately processed. The storage media 200, 300, and 400 are not limited to specific storage media, but are generally represented by the hard disk 120, the IC card 131, the CD-ROM 132, etc. shown in FIG. 2.

The storage medium 200 stores a service providing program 210. The service providing program 210 is configured by a policy evaluation section 211, a function execution section 212, a policy management section 213, and an attribute information management section 214. These sections 211 to 214 are installed and executed in the computer configuring the equipment 10 shown in FIG. 1, and configure the policy evaluation section 15, the function execution section 16, the policy management section 13, and the attribute information management section 14 shown in FIG. 1 in combination with the hardware of the computer configuring the equipment 10. The effects of the sections 211 to 214 are explained above by referring to FIG. 1, and overlapping explanation is omitted.

The storage medium 300 shown in FIG. 3 stores an attribute information file 310.

The attribute information is managed for each user, and the attribute information can be a basic material evaluating whether or not the user is qualified for receiving a service. The attribute information file 310 can be stored in the equipment which provides a service as shown by the equipment 10 in FIG. 1, can be stored in the equipment other than the equipment for providing a service such as the equipment 20, or can be stored in a portable storage medium such as the IC card 131 accessed by the equipment 30.

The storage medium 400 shown in FIG. 3 stores a policy description file 410. The policy description file 410 comprises a condition description section 411 and a service description section 412, and the service description section 412 is further configured by a role (function, responsibility) description section 412a and a contents description section 412b.

The condition description section 411 is a portion describing the condition of receiving a service described in the service description section 412, and defines a necessary condition for using a service.

The role description section 412a of the service description section 412 defines the information required to perform a service about, for example, how a service in the service description section 412 is performed, etc. Furthermore, the contents description section in the service description section 412 defines the information about, for example, the storage position of a program code for performing the service and the contents accessed by the service, etc. A practical example is described later.

The policy description file 410 stored in the storage medium 400 shown in FIG. 3 is transferred by copying it from terminal to terminal through the peer-to-peer communications (communications performed between terminals without a server). In one example, the policy description file 410 may be carried by a user after being stored in a portable storage medium such as, for example, an IC card, etc. together with the attribute information file 310, etc., and then transferred from the IC card, etc. to the equipment for providing a service to be stored in the storage medium that also stores the service providing program 210.

For convenience, as shown in FIG. 1, it is assumed that all of the service providing program 210, the attribute information file 310, and the policy description file 410 are installed in the equipment 10 shown in FIG. 1. However, it is also assumed that the attribute information is divided into user sections and stored in the attribute information DB 21 provided in the equipment 20, and the IC card 131 accessed by the equipment 30.

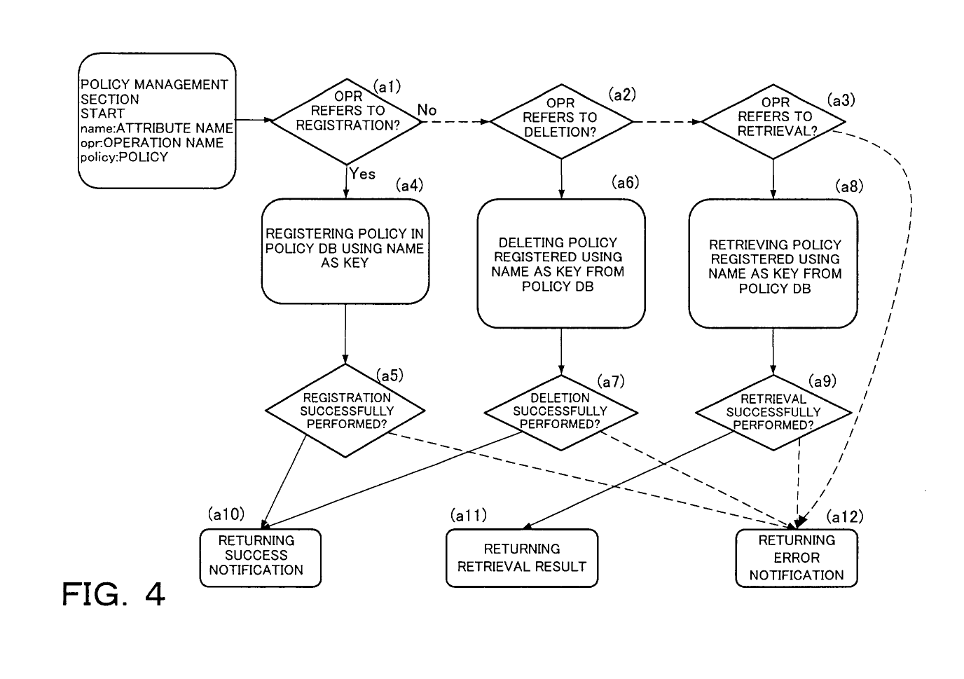

FIG. 4 is a flowchart of the operation of the policy management section 13 configuring the service providing system shown in FIG. 1.

The policy management section 13 receives necessary information indicating name: attribute name of policy, opr: operation name, and policy: policy, and determines whether opr refers to registration (step a1), deletion (step a2), or retrieval (step a3). If ‘opr’ refers to none of them, then an error notification is returned (step a12).

If opr refers to registration (step a1), the policy is registered in the policy DB using the name as a key (step a4). If the registration is successfully performed (step a5), then a success notification is returned (step a10). If the registration fails (step a5), then an error notification is returned (step a12).

If opr refers to deletion (step a2), then the registered policy is deleted from the policy DB using the name as a key (step a6). If the deletion is successfully performed (step a7), then a success notification is returned (step a10). If the deletion fails (step a7), then an error notification is returned (step a12).

If opr refers to retrieval, the policy registered is retrieved from the policy DB using the name as a key (step a8). If the retrieval is successfully performed (step a9), then a retrieval result is returned (step a11). If the retrieval fails (step a9), then an error notification is returned (step a12).

FIG. 5 is a flowchart of the operation of the attribute information management section 14 configuring the service providing system shown in FIG. 1.

In this example, necessary information about name: attribute name of attribute information, opr: operation name, or value: attribute value is received and it is determined whether opr refers to registration (step b1), deletion (step b2) or retrieval (step b3). If opr refers to none of them, an error notification is returned (step b15).

If opr refers to registration (step b1), then the value is registered in the attribute information DB 12 of the equipment 10 using the name as a key (step b4). If the attribute information file of the user registering the attribute information is stored in the attribute information DB 21 of the equipment 20 or in the IC card 131, then a registration request message (name, registration, value) is issued to the attribute information message processing section of the equipment 20 or 30, and a result as to whether or not the registration is successfully performed is obtained (step b5). When the registration is successfully performed (step b6), then a successful registration notification is returned (step b13). If the registration fails (step b6), then an error notification is returned (step b15).

If opr refers to deletion (step b2), the attribute value registered is deleted from the attribute information DB 12 of the equipment 10 using the name as a key (step b7), and the deletion request message (name, deletion, value) is transmitted to the attribute information message processing sections of the equipment 20 and 30, and obtains the results from the equipment 20 and 30 as to whether or not the deletion has been successfully performed (step b8). When the deletion is successfully performed, that is, the attribute value is deleted from the attribute information DB 12 of the equipment (equipment 10), or a result informing that the deletion has been successfully performed can be obtained from any of the equipment 20 or 30 (step b9), then a success notification is returned (step b13). If the deletion fails, then an error notification is returned (step b15).

If opr refers to retrieval (step b3), then the attribute registered is retrieved from the attribute information DB 12 of the equipment (equipment 10) using the name as a key (step b10), a retrieval request message (name, retrieval) is transmitted to the attribute information message processing sections of the equipment 20 and 30, and retrieval results are obtained from the equipment 20 and 30 (step b11). As a result, if the retrieval is successfully performed (step b12), then a retrieval result is returned (step b14). If the retrieval fails (step b12), an error notification is returned (step b15).

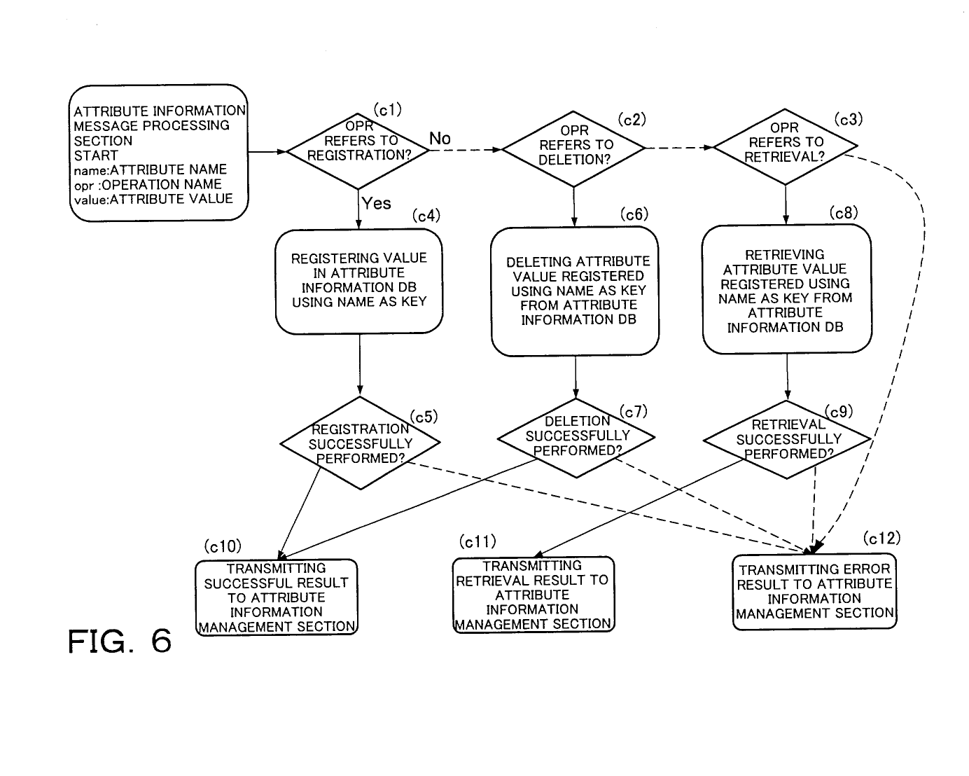

FIG. 6 is a flowchart of the operation of the attribute information message processing sections of the equipment 20 and 30 shown in FIG. 1.

A message is received using a necessary variable as an argument among name: attribute name, opr: operation name, value: attribute value, and it is determined whether opr refers to registration (step c1), deletion (step c2), or retrieval (step c3). If it refers to none of them, then an error result is transmitted to the attribute information management section (step c12).

If opr refers to registration (step c1), then the value is registered in the attribute information DB 21 (IC card 131 in the case of the equipment 30) of the equipment 20 using the name as a key (step c4). If the registration is successfully performed (step c5), then a success notification is transmitted to the attribute information management section 14 of the equipment 10 shown in FIG. 1 (step c10). If the registration fails (step c5), then an error notification is transmitted to the attribute information management section 14 (step c12).

If opr refers to deletion (step c2), then the attribute value registered is deleted from the attribute information DB 21 (IC card 131 in the case of the equipment 30) of the equipment 20 using the name as a key (step c6). When the deletion is successfully performed (step c7), then a success result is transmitted to the attribute information management section 14 of the equipment 10 (step 10). If the deletion fails (step c7), then an error result is transmitted to the attribute information management section 14 (step c12).

If opr refers to retrieval (step c3), the attribute value registered is retrieved from the attribute information DB 21 (IC card 131 in the case of the equipment 30) of the equipment 20 using the name as a key (step c8). If the retrieval is successfully performed (step c9), then a retrieval result is transmitted to the attribute information management section 14 of the equipment 10 (step c11). If the retrieval result indicates a failure (step c9), then an error result is transmitted to the attribute information management section 14 of the equipment 10 (step c12).

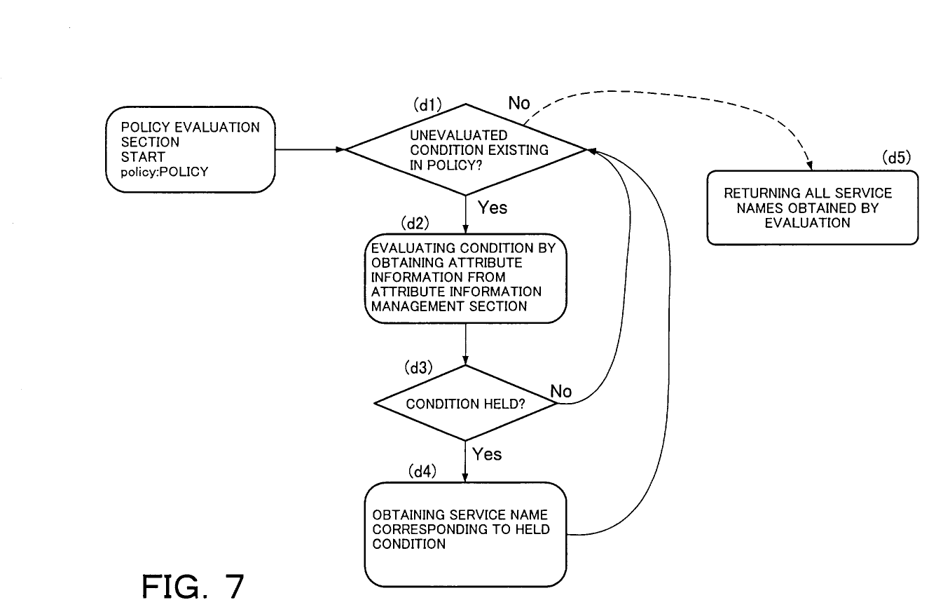

FIG. 7 is a flowchart of the operation of the policy evaluation section 15 of the equipment 10 of the service providing system shown in FIG. 1.

The policy evaluation section 15 receives the policy to be evaluated, and it is determined whether or not an unevaluated condition exists in the condition description section in the policy (step d1). If an unevaluated condition exists, then attribute information is obtained from the attribute information management section to evaluate the condition (step d2). If the condition holds (step d3), that is, if the attribute information satisfying the condition exists, then a service name corresponding to the condition is obtained (step d4). If all conditions in the policy are completely evaluated (step d1), then all service names obtained in the evaluation are returned (step d5).

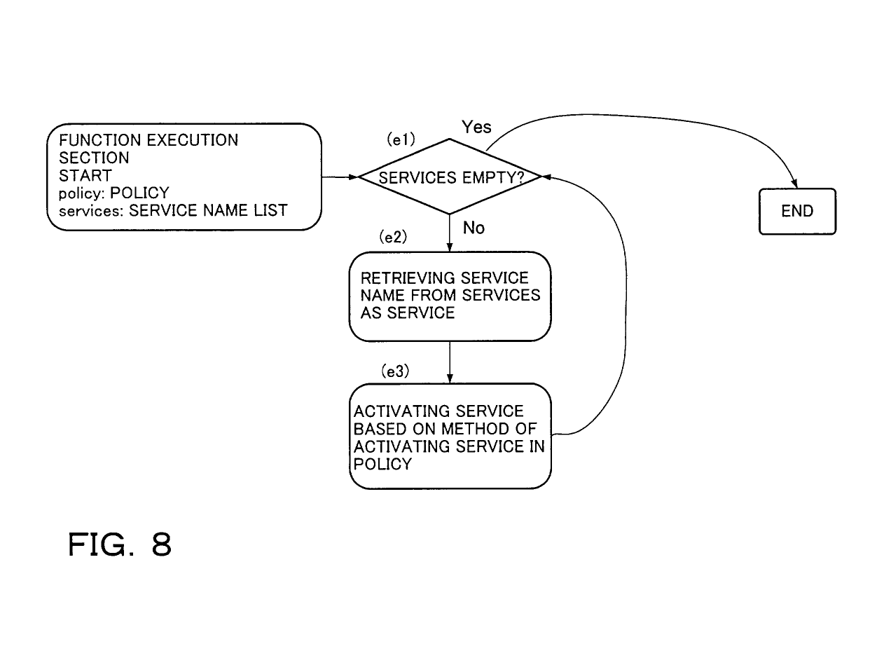

FIG. 8 is a flowchart of the operation of the function execution section 16 of the equipment 10 of the service providing system shown in FIG. 1.

The function execution section receives policy: policy and services: service name list, it is determined whether or not the services is empty (step e1). If the services is not empty and describes a service name, then the service name is retrieved from the services and recognizes it as a service to be provided (step e2), and the service is activated according to the method of activating the service described in the policy (step e3).

The above mentioned process is performed on all service names listed in the services. When there are no unprocessed services remaining the services (when the services is empty)(step e1), then the process terminates.

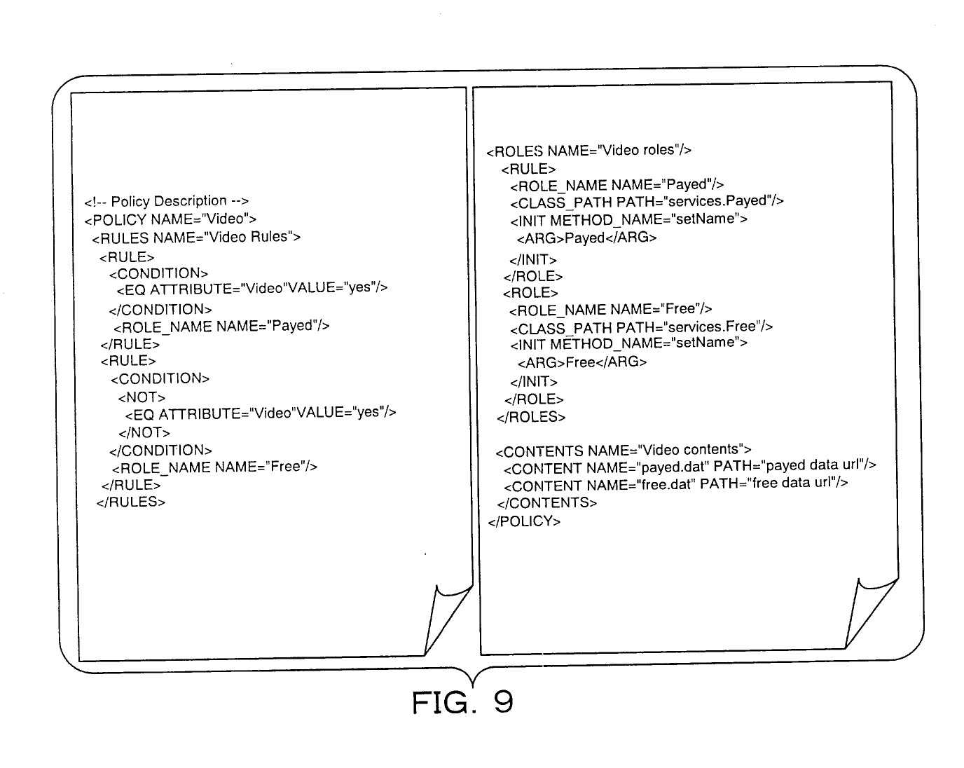

FIG. 9 shows an example of a policy.

In FIG. 9, one policy is shown covering two left and right pages. The left page of these two pages is a condition description section, and the right page is a service description section.

The policy in FIG. 9 describes a service of a video broadcast. First, a digest version, etc. is displayed free of charge, and then a user who pays a corresponding fee receives a video broadcast in details.

The condition description section on the left page indicates that if the attribute name ‘Video’ is an attribute value ‘yes’, then a service named ‘Payed’ can be obtained, and that if the attribute name ‘Video’ is not an attribute value ‘yes’, then a service named ‘Free’ can be obtained.

In this example, it is assumed that the attribute information file of a user includes an attribute name ‘Video’, and the attribute name ‘Video’ can have an attribute value ‘yes’, or cannot have the value ‘yes’ (or the attribute name ‘Video’ is not assigned).

The <ROLES_NAME=‘Video roles’>˜</ROLES> of the service description section shown on the right in FIG. 9 indicates a role (function) description section indicating that, to offer a service named ‘Payed’, a program ‘services.Payed’ is activated, and a function ‘setName’ is performed using Payed as an argument, and that, to offer a service named ‘Free’, a program ‘services.Free’ is activated, and a function ‘setName’ is performed using Free as an argument.

The <CONTENTS NAME=“Video contents’>˜</CONTENTS> on the right page indicates a contents description section. In the example, it indicates that a file ‘payed.dat’ at the address of ‘payed data url’ is to be accessed by the program ‘services.Payed’, and that the program ‘services.Free’ is to access the file ‘free.dat’ at the address of ‘free data url’.

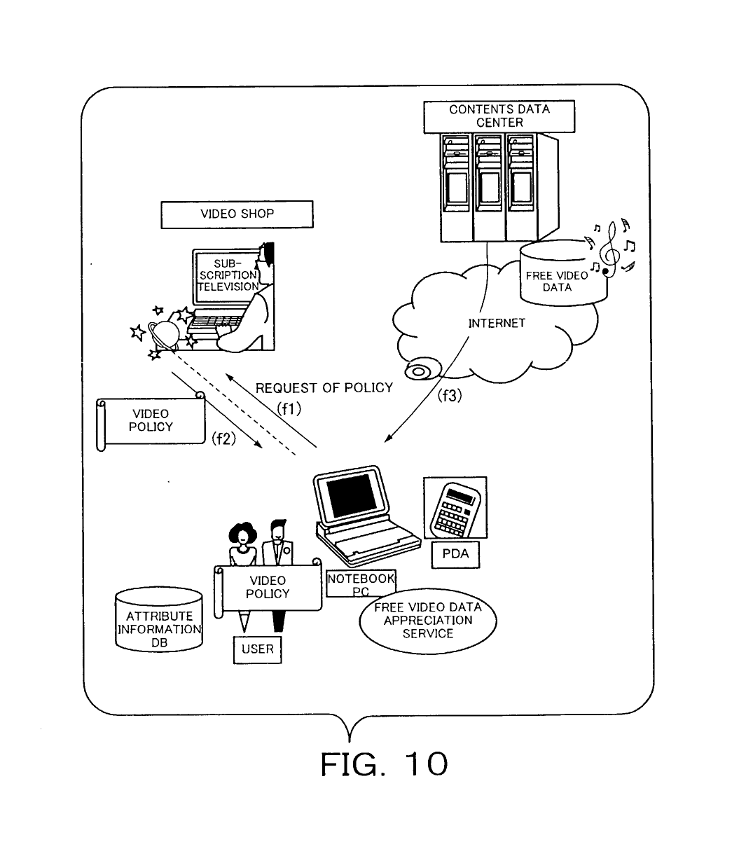

FIGS. 10 to 12 are embodiments of the present invention. In this example, the policy shown in FIG. 9 is used.

First, as shown in FIG. 10, a user requests a video shop to have a video broadcast service after watching a demonstration video. That is, the user requests the video shop for a policy (step f1). In response to the request, the video shop transmits a video policy to the equipment such as a notebook personal computer (notebook PC), a PDA, etc. of the user. (step f2). In this stage, the attribute value of the attribute name ‘Video’ of the attribute information DB of the user is not ‘yes’, but is set to ‘no’, or there is no attribute name ‘Video’. Therefore, a service named ‘Free’ shown in FIG. 8 can be offered. The free video data is in the file ‘free.dat’ in the contents data center. The address ‘free data url’ is accessed from the notebook PC or the PDA of the user, so that the free video data is downloaded from the contents data center through Internet, and the free demonstration video can be displayed on the notebook PC or the PDA.

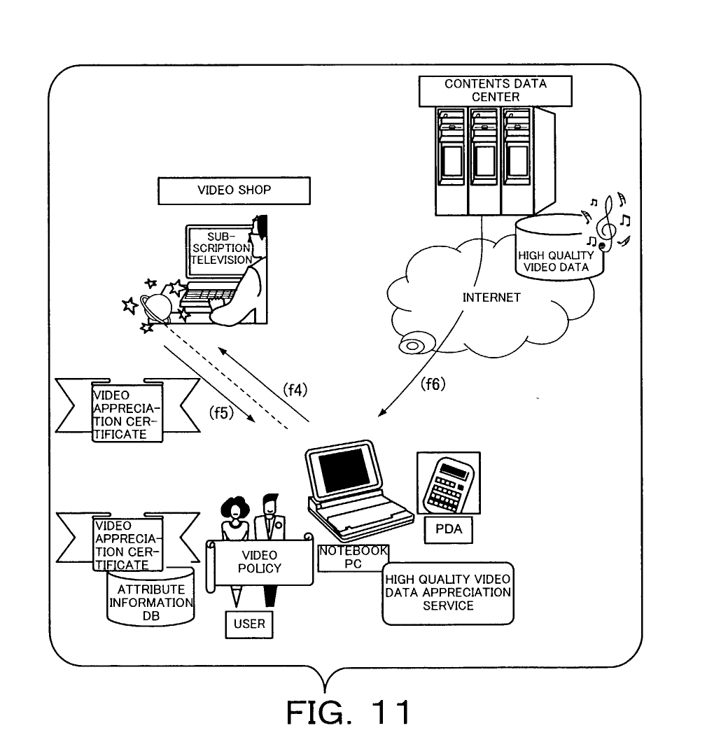

When the user formally requests to see the video, the user pays the fee to the video shop as shown in FIG. 11 (step f4). Then, the video shop issues a video appreciation certificate to a notebook PC or a PDA, etc. of the user (step f5). That the user receives the video appreciation certificate corresponds to rewriting the attribute value of the attribute name ‘Video’ in the attribute information DB of the user into ‘yes’.

To satisfy the condition of ‘Payed’ of the condition description section in the video policy, the formal high quality video data is downloaded from the contents data center, and the user can enjoy the high quality video on his or her notebook PC or PDA, etc.

However, the notebook PC and PDA have small screens although they are convenient as mobile sections. Therefore, there will be described a case where a user can enjoy the video on the large screen when the user has moved to an environment in which a large screen can be used.

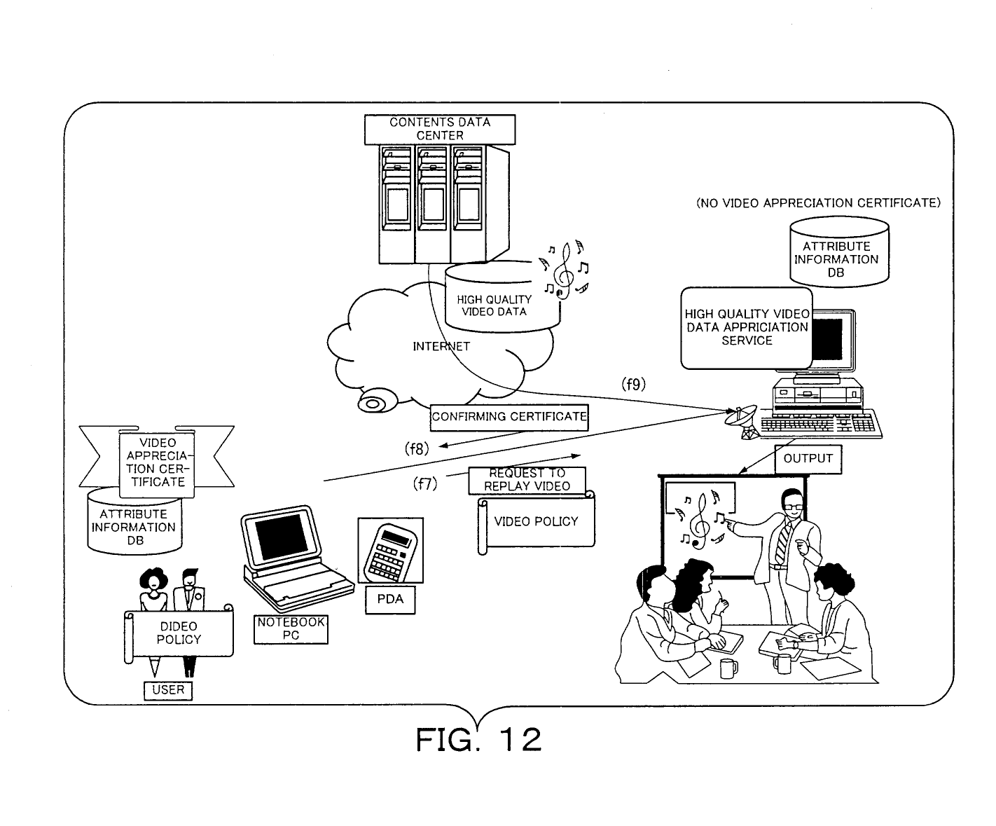

FIG. 12 shows a large screen and a computer for controlling images displayed on the screen. It is assumed that the computer in which the service providing program shown in FIG. 3 is installed, but, in the attribute information DB storing the attribute information about the administrator controlling the computer, there is no video appreciation certificate (attribute value ‘yes’ of the attribute name ‘Video’) of the system described in the present embodiment.

Therefore, the peer-to-peer communications are performed between the notebook PC or PDA of the user and the computer controlling the screen, and a request to copy and transfer the video policy and play back the video is issued from the notebook PC or PDA of the user to the computer (step f7). Then, the computer asks the notebook PC or PDA for the video appreciation certificate, confirms its existence (step f8), and permits downloading the high quality video data from the contents data center. The computer then displays the video on the large screen controlled by the computer. In this system, the user can receive a service using the equipment at the destination anywhere.

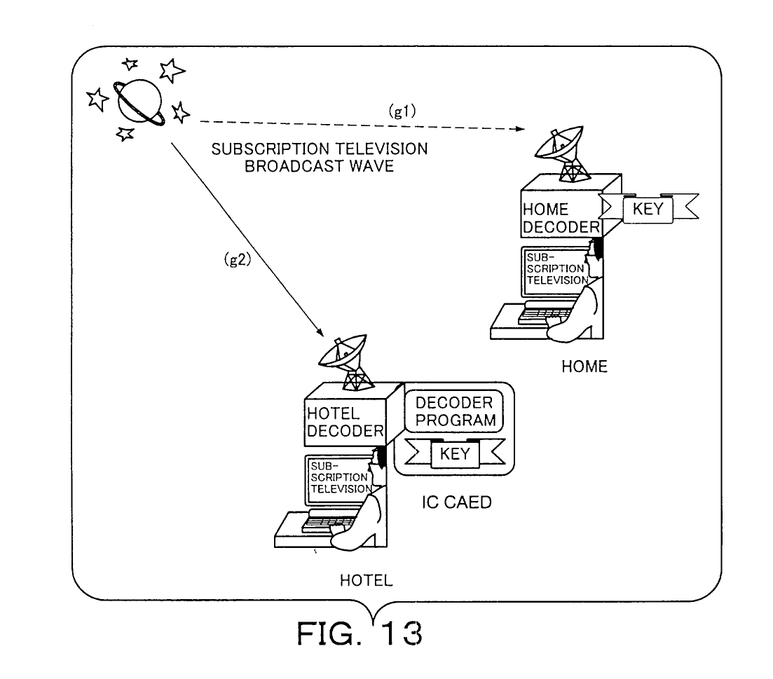

FIG. 13 shows another use style of the present invention.

A user normally uses a home decoder to watch subscription television at home. On a business trip, the user carries an IC card containing a decoder program and a key for watching the subscription television. The decoder program is a type of policy, and the key is a type of attribute information.

In a hotel on a business trip, the user presents the decoder program (policy) to the decoder of the hotel. The decoder of the hotel confirms the key (attribute information) in the IC card, and executes the decoder program. The user can appreciate the subscription television, to which the hotel does not subscribe, based on the user subscription to the television.

What is claimed is:

1. A service providing software system storage medium storing a service providing software system, the system comprising:
an attribute information file describing attribute information which is a material for evaluation of qualification for receiving a service;
a policy description file having a condition description section describing a condition of receiving a service, and a service description section directly or indirectly describing a service to be provided when the condition described by the condition description section is satisfied; and
a service providing program which is executed in a computer and directs the computer to operate as a service providing device including a policy evaluation section for obtaining information indicating whether or not an attribute information file includes attribute information satisfying the condition described in the condition description section in the policy description file, and a function execution section for interpreting the description of the service described in the service description section of the policy description file, depending on the acquisition by the policy evaluation section of the information indicating the existence of the attribute information matching the condition.

2. The service providing software system storage medium according to claim 1, wherein the attribute information file cannot be transferred from the storage medium storing the attribute information file to another storage medium or can be transferred after a predetermined authentication procedure.

3. The service providing software system storage medium according to claim 1, wherein the policy description file can be distributed after being copied through peer-to-peer communications.

4. A service providing program storage medium storing a service providing program which is executed in a computer and directs the computer to operate as a service providing device providing a service, the service providing device comprising: a policy evaluation section for obtaining information indicating whether or not an attribute information file describing attribute information which is a material for evaluation of qualification for receiving a service includes attribute information satisfying the condition described in a condition description section in the policy description file having a condition description section describing a condition of receiving a service, and a service description section directly or indirectly describing a service to be provided when the condition described by the condition description section is satisfied; and a function execution section for interpreting the description of the service described in the service description section of the policy description file, depending on the acquisition by the policy evaluation section of the information indicating the existence of the attribute information matching the condition.

5. The service providing program storage medium according to claim 4, wherein the attribute information file cannot be transferred from the storage medium storing the attribute information file to another storage medium or can be transferred after a predetermined authentication procedure.

6. The service providing program storage medium according to claim 4, wherein the policy description file can be distributed after being copied through peer-to-peer communications.

7. A service providing system, comprising:
an attribute information storage section storing an attribute information file describing attribute information which is a material for evaluation of qualification for receiving a service;
a policy storage section storing a policy description file having a condition description section describing a condition of receiving a service, and a service description section directly or indirectly describing a service to be provided when the condition described by the condition description section is satisfied;
a policy evaluation section obtaining information indicating whether or not an attribute information file includes attribute information satisfying the condition described in the condition description section in the policy description file; and
a function execution section interpreting the description of the service described in the service description section of the policy description file, depending on the acquisition by the policy evaluation section of the information indicating the existence of the attribute information matching the condition.

8. The service providing system according to claim 7, wherein the attribute information storage section is provided in another device than a device including the policy evaluation section, and the policy evaluation section inquires of the device including the attribute information storage section whether or not attribute information satisfying the condition described in the condition description section in the policy description file exists in the attribute information file, and obtains the information as to whether or not the attribute information exists according to an answer from the device including the attribute information storage section.

9. The service providing system according to claim 7, wherein the attribute information storage section can store the attribute information file such that the file cannot be transferred to a storage medium other than the attribute information storage section, or such that the file can be transferred only after a predetermined authentication procedure.

10. The service providing system according to claim 7, wherein the policy storage section can store the policy description file such that the file can be freely distributed through the peer-to-peer communications.

11. A service providing device, comprising:
a policy evaluation section obtaining information indicating whether or not an attribute information file describing attribute information which is a material for evaluation of qualification for receiving a service includes attribute information satisfying a condition described in a condition description section in a policy description file having a condition description section describing a condition of receiving a service, and a service description section directly or indirectly describing a service to be provided when the condition described by the condition description section is satisfied; and
a function execution section interpreting the description of the service described in the service description section of the policy description file, depending on the acquisition by the policy evaluation section of the information indicating the existence of the attribute information matching the condition.

12. The service providing device according to claim 11, wherein the attribute information file is stored in an attribute information storage medium other than the service providing device, and the policy evaluation section directly accesses the attribute information storage medium or inquires of the device for accessing the attribute information storage medium to obtain the information as to whether or not the attribute information satisfying the condition described in the condition description section in the policy description file is included in the attribute information file stored in the attribute information storage medium.

13. The service providing device according to claim 11, wherein the attribute information file cannot be transferred from the storage medium storing the attribute information file to another storage medium or can be transferred after a predetermined authentication procedure,

14. The service providing device according to claim 11, wherein the policy description file can be distributed after being copied through peer-to-peer communications.
